(19) United States
(12) Patent Application Publication
(10) Pub. No.: US 2007/0201008 A1
(43) Pub. Date: Aug. 30, 2007

(54) Projection Device with an Electromagnetic Interference Shielding Slice

(76) Inventor: Hsien-Feng Lin, Hsin-Chu Hsien (TW)

Correspondence Address: NORTH AMERICA INTELLECTUAL PROPERTY CORPORATION, P.O. BOX 506, MERRIFIELD, VA, 22116, US

(21) Appl. No.: 11/556,203

(22) Filed: Nov. 3, 2006

(30) Foreign Application Priority Data
Nov. 23, 2005 (TW) 094141193

(51) Int. Cl. G03B 21/16; G03B 21/18

(52) U.S. Cl. 353/52

(57) ABSTRACT

A DLP projection device includes a cooling fin of a DMD chip, a cover of an optical engine, a mother board, a metal sheet covering the mother board, an upper housing covering the DLP projection device, and an EMI shielding slice coupled with the cooling fin of the digital micro mirror display chip, the cover of the optical engine, and the metal sheet. The EMI shielding slice is also attached to the upper housing.

### BACKGROUND OF THE INVENTION

1. Field of the Invention

The present invention relates to a projection device, and more particularly, to a DLP projection device with an EMI shielding slice.

2. Description of the Prior Art

In order to reduce overall weight and cost, housings of most of the modern digital light processing (DLP) projection devices are made of plastic instead of iron or metal. However, plastic housings are ineffective in shielding electromagnetic waves. It might help a little by coating the plastic housings with conducting paint. But the ingredients of the conducting paint are harmful to environments. Further, consumers are more favorable to smaller DLP projection devices. However, to keep the DLP projection devices small, there will not be enough room to accommodate sufficient electromagnetic interference (EMI) suppressing units. For the reasons above, the DLP projection devices might suffer severe EMI problems and have difficulties to overcome it. Hence the performance is affected.

### SUMMARY OF THE INVENTION

Briefly described, the claimed invention discloses a DLP projection device including a cooling fin of a DMD chip, a cover of an optical engine, a mother board, a metal sheet covering the mother board, and an EMI shielding slice coupled with the cooling fin of the DMD chip, the cover of the optical engine, and the metal sheet.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a DLP projection device of the present invention.

FIG. 2 is a diagram of a DLP projection device of the present invention with an upper housing removed.

FIG. 3 is a diagram of the upper housing of the DLP projection device of the present invention.

### DETAILED DESCRIPTION

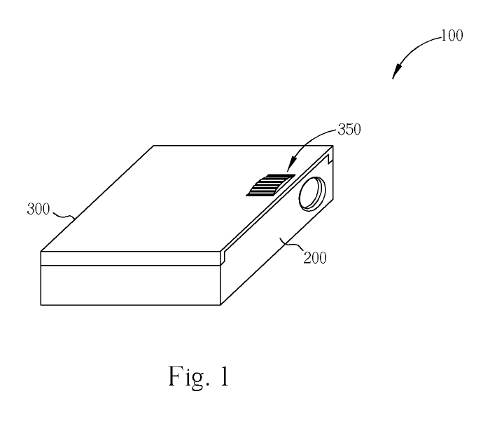

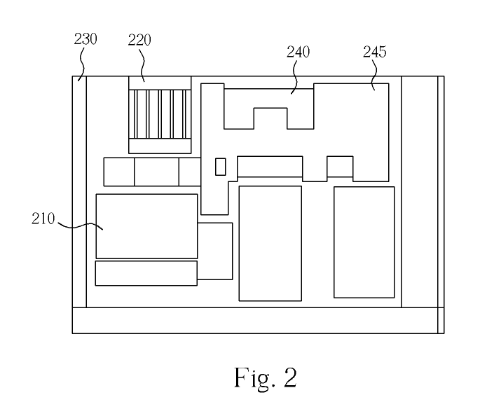

Please refer to FIG. 1. FIG. 1 is a diagram illustrating a DLP projection device 100 of the present invention. As shown in FIG. 1, the DLP projection device 100 includes a main machine 200 and an upper housing 300. A knob for adjusting the lens of the main machine 200 is partially exposed out from a square hole 350 on the upper housing 300. Please refer to FIG. 2. FIG. 2 is a diagram of a DLP projection device 200 of the present invention with the upper housing 300 removed. The main machine 200 comprises a cooling fin 210 of a digital micro mirror display (DMD) chip, an upper cover 220 of an optical engine, a metal sheet 230 covering a mother board, a power board 240, and a metal sheet 245 covering the power board 240. It is seen in FIG. 2 that there is no EMI suppressing unit in the DLP projection device.

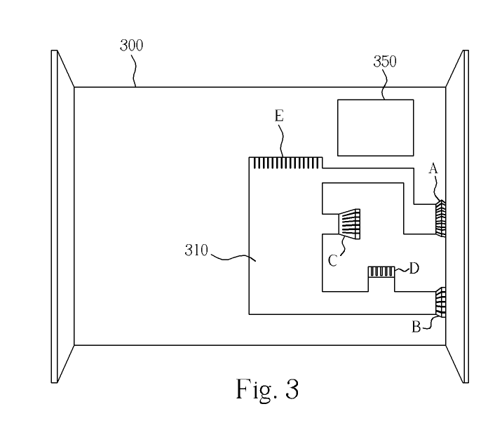

Please refer to FIG. 3. FIG. 3 is a diagram illustrating the upper housing 300 of the DLP projection device 100. The DLP projection device 100 includes an EMI shielding slice 310 attached to the upper housing 300. As displayed in FIG. 3, the present EMI shielding slice 310 includes a plurality of strips A, B, C, D and E. When the upper housing 300 covers the main machine 200, these strips contact grounds and conductive parts of some components of the main machine 200. For example, the strip A and the strip B contact the metal sheet 230 that covers the mother board, the strip C contacts the cover 220 of the optical engine, and the strip D contacts the cooling fin 210 of the DLP projection device. Furthermore, the strip E may be utilized to contact the metal sheet 245 that covers the power board 240. The EMI shielding slice 310 of the present invention may be strips-like in order to contact different grounds and conductors as illustrated in FIG. 3, or may be implemented by other forms as long as the EMI shielding slice 310 can contact the grounds and the conductors when the upper housing of the projection device is assembled and coupled to the main machine.

The DLP projection device of the present invention utilizes an EMI shielding slice 310 installed on the upper housing 300 to connect the grounds and the conductive parts of the main components of the main machine 200. Hence the EMI shielding is improved without increasing the size and weight of the DLP projection device, and without damaging the environment since no conducting paint is used. The present invention equalizes ground levels by bridging different grounds within the DLP projection device, shortens the grounding path of separate circuits, and alleviates the problems of EMI thereof.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A digital light processing (DLP) projection device comprising:
a cooling fin of a digital micro mirror display (DMD) chip;
a cover of an optical engine;
a mother board;
a metal sheet covering the mother board; and
an electromagnetic interference (EMI) shielding slice coupled with the cooling fin of the digital micro mirror display chip, the cover of the optical engine, and the metal sheet.

2. The DLP projection device of claim 1 further comprising a shielding slice of a power board, wherein the EMI shielding slice is further coupled to the shielding slice of the power board.

3. The DLP projection device of claim 1 wherein the EMI shielding slice is conductive.

4. The DLP projection device of claim 1 wherein the EMI shielding slice is made of tinplate.

5. The DLP projection device of claim 1 further comprising a first circuit, wherein the EMI shielding slice is further coupled to ground of the first circuit.

6. The DLP projection device of claim 1 further comprising an upper housing covering the DLP projection device wherein the EMI shielding slice is attached to the upper housing.
